(19) United States
(12) Patent Application Publication
(10) Pub. No.: US 2008/0055642 A1
(43) Pub. Date: Mar. 6, 2008

(54) Information processing system and server

(75) Inventor: Masakatsu Nakamura, Nara (JP)

Correspondence Address: EDWARDS ANGELL PALMER & DODGE LLP, P.O. BOX 55874, BOSTON, MA, 02205, US

(73) Assignee: Sharp Kabushiki Kaisa, Osaka (JP)

(21) Appl. No.: 11/894,223

(22) Filed: Aug. 20, 2007

(30) Foreign Application Priority Data
Sep. 6, 2006 (JP) 2006-241611

(51) Int. Cl. G06F 3/12

(52) U.S. Cl. 358/1.15

(57) ABSTRACT

It is the object of the present invention to enable various information processing by combining an image processing apparatus with peripheral devices without equipping the apparatus with device drivers or application software for each of the peripheral devices. By connecting a plurality of image processing apparatuses (digital multi-function peripherals), peripheral devices (USB-Hubs), and a server that manages the connection between these digital multi-function peripherals and the USB-Hubs and is equipped with device drivers and application software for various types of peripheral devices to be utilized by connection to the USB-Hubs by a network, the present invention enables utilization of the peripheral devices that can not be utilized by connecting directly to the image processing apparatuses in combination with the image processing apparatuses.

### CROSS-NOTING PARAGRAPH

This Nonprovisional application claims priority under 35 U.S.C. §119(a) on Patent Application No. 2006-241611 filed in JAPAN on Sep. 6, 2006, the entire contents of which are hereby incorporated herein by references.

### FIELD OF THE INVENTION

The present invention relates to an information processing system, and a server, designed to be capable of performing various information processing by combining an image processing apparatus (digital multi-function peripheral) and peripheral devices.

### BACKGROUND OF THE INVENTION

In recent years, a digital multi-function peripheral as an image processing apparatus is undergoing further enhancement in its multi-functionality and such a digital multi-function peripheral is provided that has a USB connector enabling it to transmit and receive data to and from a USB memory. As described in Japanese Laid-Open Patent Publication No. 2004-78359, some system utilizes the USB (Universal Serial Bus) for connecting a printer with various devices by way of a network.

However, in advancing the multi-functionalization of the digital multi-function peripheral, it brings about problems such as a cost increase and difficulty of maintenance to equip the digital multi-function peripheral with all of the device drivers enabling the use of various peripheral devices by taking future trends into account.

### SUMMARY OF THE INVENTION

It is the object of the present invention to provide an information processing system and a multi-functionalized server that are capable of performing various types of information processing by combining a digital multi-function peripheral as an image processing apparatus with various peripheral devices, without equipping the digital multi-function peripheral with a lot of device drivers, etc.

A first technical means is an information processing system in which an image processing apparatus, a communication connection device to which a peripheral device is connected, and a server are connected to a network, wherein the server has a function of managing the connection between the image processing apparatus and the communication connection device and supporting information processing to be performed by the peripheral device connected to the communication connection device in cooperation with the image processing apparatus.

A second technical means is the information processing system as defined in the first technical means, wherein the network is a LAN.

A third technical means is the information processing system as defined in the first technical means, wherein the image processing apparatus and the communication connection device are assigned their IP addresses.

A fourth technical means is the information processing system as defined in the first technical means, wherein a group management is executed on the image processing apparatus and the communication connection device by the server.

A fifth technical means is the information processing system as defined in the fourth technical means, wherein the group management is performed according to IP addresses.

A sixth technical means is the information processing system as defined in the first technical means, wherein the communication connection device is a USB hub.

A seventh technical means is a server for connecting to a network an image processing apparatus and a communication connection device to which a peripheral device is connected, the server equipped with a device driver that enables the peripheral device connected to the communication connection device to be utilized to work in cooperation with the image processing apparatus.

An eighth technical means is the server as defined in the seventh technical means, having a group management function of executing a group management on the image processing apparatus and the communication connection device.

A ninth technical means is the server as defined in the seventh technical means, provided with a connected device recognizing function of recognizing the peripheral device connected to the communication connection device when the peripheral device is connected to the communication connection device.

A tenth technical means is the server as defined in the seventh technical means, provided with a processing procedure management table recording a processing procedure for executing information processing utilizing the peripheral device connected to the communication connection device when the peripheral device is connected to the communication connection device.

An eleventh technical means is the server as defined in the tenth technical means, wherein the processing procedure corresponding to the connected peripheral device is decided based on management information of the group management and information on the connected device as recognized by the connected device recognizing function.

A twelfth technical means is the server as defined in the tenth technical means, storing and managing GUI screen data to be displayed on an operation unit of the image processing apparatus and providing the image processing apparatus with predetermined GUI screen data in accordance with the progress of the information processing.

A thirteenth technical means is the server as defined in the tenth technical means, equipped with a function of converting the format of the data provided by the peripheral device that can not be handled by the image processing apparatus to a format that can be handled by the image processing apparatus.

### BRIEF DESCRIPTION OF THE DRAWINGS

FIG. 1 is a block diagram for description of a configuration of a digital multi-function peripheral as an example of an image processing apparatus used in the present invention;

FIG. 2 is a block diagram of an information processing system according to embodiments of the present invention;

FIG. 3A is a functional block diagram of a server used in the information processing system of the present invention;

FIG. 3B is an explanatory diagram for the case of group management of digital multi-function peripherals and USB-hubs connected to a network;

FIG. 4 is a diagram of a display example of a job selection screen displayed on an operation panel of the digital multi-function peripheral;

FIG. 5 is a diagram of an example of a system configuration in POP printing;

FIG. 6 is a processing sequence chart in a POP printing job;

FIGS. 7A and 7B are diagrams of display examples of the operation screen in the POP printing job;

FIG. 8 is a diagram of a processing procedure of the POP printing job stored in a server;

FIG. 9 is a processing sequence chart in a scan USB job;

FIGS. 10A and 10B are diagrams of display examples of the operation screen in the scan USB job;

FIG. 11 is a diagram of a processing procedure of the scan USB job stored in the server;

FIG. 12 is a typically represented diagram of files stored in a USB memory;

FIG. 13 is a diagram of a processing sequence in a USB memory printing job;

FIGS. 14A to 14D are diagrams of display examples of the operation screen in the USB memory printing job;

FIG. 15 is a diagram of a processing sequence of the USB memory printing job stored in the server;

FIG. 16 is a diagram of a processing sequence in an attaching to mail job;

FIGS. 17A to 17D are diagrams of display examples of the operation screen in the attaching to mail job; and

FIG. 18 is a diagram of a processing sequence of the attaching to mail job stored in the server.

### PREFERRED EMBODIMENTS OF THE INVENTION

In the following, description will be made of preferred embodiments of the present invention, with reference to drawings.

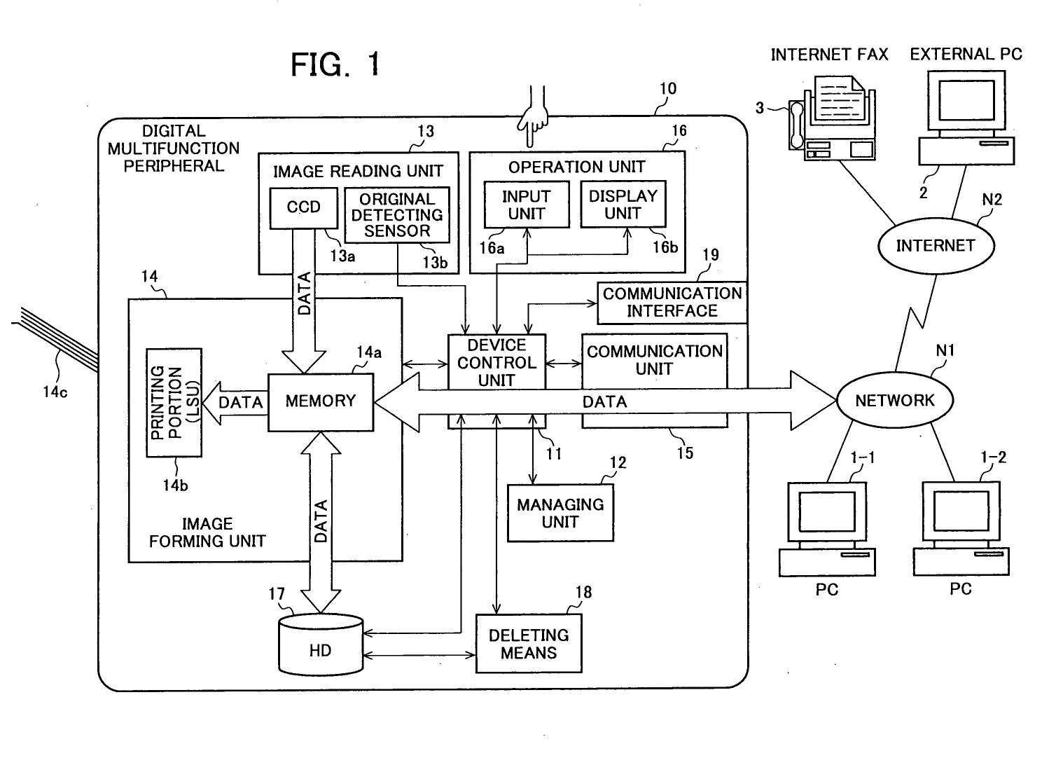

FIG. 1 is a block diagram of an example of a digital multi-function peripheral (MFP) as an example of an image processing apparatus utilized in an information processing system of the present invention. This digital multi-function peripheral 10 is configured as a multi-function peripheral having functions of a copier, a printer device, a facsimile device, a scanner device, etc. This digital multi-function peripheral 10 is connected to a plurality of personal computers 1-1, 1-2 (hereinafter, PCs) by way of a communication network N1 such as an in-house LAN and can exchange information with the PCs. Furthermore, the digital multi-function peripheral 10 can transmit and receive information to and from external devices 2, 3 (PC 2, Internet Fax 3) connected to a wide area communication network N2 such as Internet.

The digital multi-function peripheral 10 is provided with a device control unit 11 comprising a CPU for performing operational processing, a RAM for temporarily memorizing processing information, a ROM for storing a control program, etc. This device control unit 11 has a connection to a managing unit 12 that manages processing performed by the digital multi-function peripheral 10 and retains management information (various types of control information) for such purpose and also has a connection to an image reading unit 13 that generates image data by reading an image recorded on an original, etc. The image reading unit 13 has a CCD 13a for taking in the image data of the original and an original detecting sensor 13b for detecting the presence of the original.

The device control unit 11 has a connection to an image forming unit 14 that forms the image data on recording paper. This image forming unit 14 is provided with a memory 14a that temporarily memorizes the read image data, a printing unit (LSU: Laser Scanning Unit) 14b that reads out the image from the image data memorized in the memory 14a and prints it on the recording paper, and a tray 14c for feeding the recording paper to the printing unit 14b. In this case, the digital multi-function peripheral 10 functions as a copier that, after memorizing the image data generated at the image reading unit 13 in the memory 14a, forms the image at the printing unit 14b.

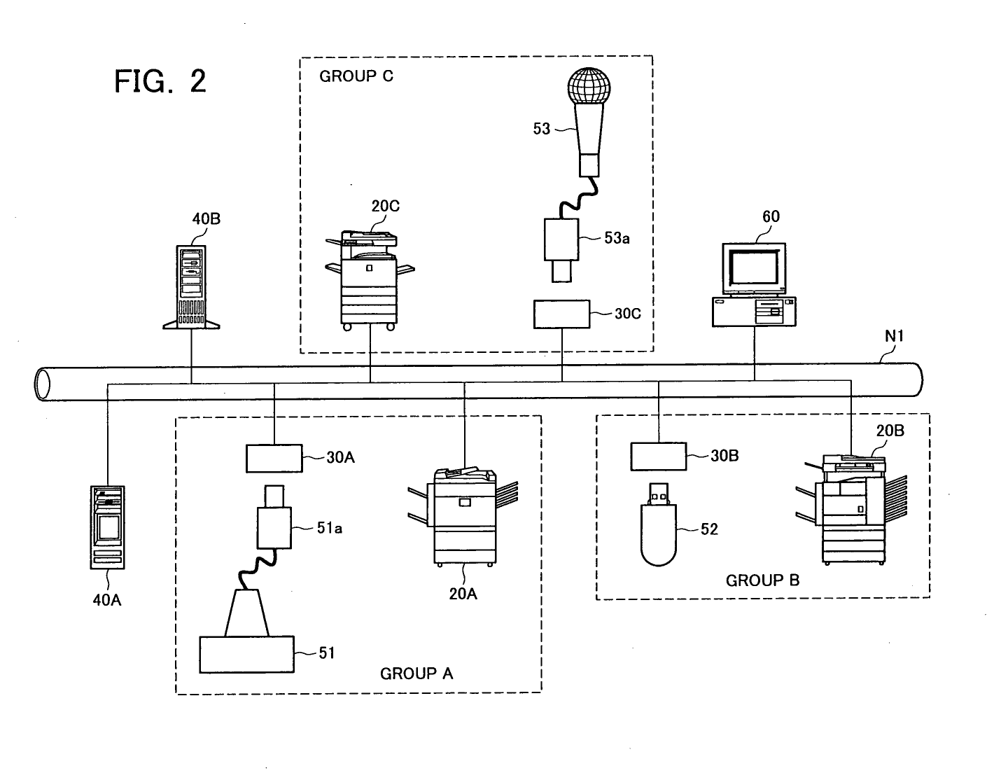

The device control unit 11 has a connection to a communication unit 15 to exchange information with the PCs FIG. 2 is a block diagram of an information processing system according to embodiments of the present invention. The system has a configuration that a plurality of digital multi-function peripherals (image processing apparatuses) 20 (20A, 20B, 20C) each of which is assigned an IP address, USB-Hubs 30 (30A, 30B, 30C) to which peripheral devices are connected, a server 40 (40A or 40B) that manages the connection between these digital multi-function peripherals 20 and the USB-Hubs 30 and includes a function of supporting the information processing that is described later, and a terminal device 60 that transmits and receives data to and from the digital multi-function peripherals, are connected to the network N1 such as the LAN.

FIG. 2 shows, for convenience of description, that a bar code reader 51, that is described later, for performing a “POP printing” job in group A comprising the digital multi-function peripheral 20A and the USB-Hub 30A, a USB memory 52, that is described later, used in performing “scan USB” and “USB memory printing” jobs in group B comprising the digital multi-function peripheral 20B and the USB-Hub 30B, and a microphone 53, that is described later, used in an “attaching to mail” job in group C comprising the digital multi-function peripheral 20C and the USB-Hub 30C are connected to their respective or external devices by way of the communication network N1, N2. In this case, the digital multi-function peripheral 10 functions as a facsimile device or a printer device of PCs (1-1, 1-2), etc.

The device control unit 11 has a connection to an operation unit 16 for inputting by a user. The operation unit 16 has an input unit 16a such as a touch panel or a ten-key board for inputting information such as a control, instruction and a display unit 16b such as a liquid crystal display for displaying information for operation. An authentication code, etc., that authenticate a manager or a user of the digital multi-function peripheral 10 is also input at this operation unit 16.

The device control unit 11 has a connection to a hard disk device (HD) 17. The HD 17 stores data related to image processing such as the image data generated by the image reading unit 13. The device control unit 11 has a connection to a deleting means, which deletes the data stored in the HD 17 as the occasion demands.

A communication interface 19, which takes in the data, for example, from a USB memory, etc., for printing, can handle only the data in the limited format and can perform only limited jobs. USB-Hubs. However, in the present invention, the server 40 that supports the information processing has a function of recognizing peripheral devices (51, 52, 53) connected to the USB-Hub 30 and therefore, if the server is equipped with device drivers that control the peripheral devices connected thereto, the peripheral devices can basically work whichever USB-Hub they are plugged into. However, since the processing procedure to be memorized in a management table can no longer be uniquely decided based on information on connection of the digital multi-function peripheral and the USB-Hub, it becomes necessary to memorize in a management table unit the processing procedure between each digital multi-function peripheral and the peripheral devices to be utilized thereby.

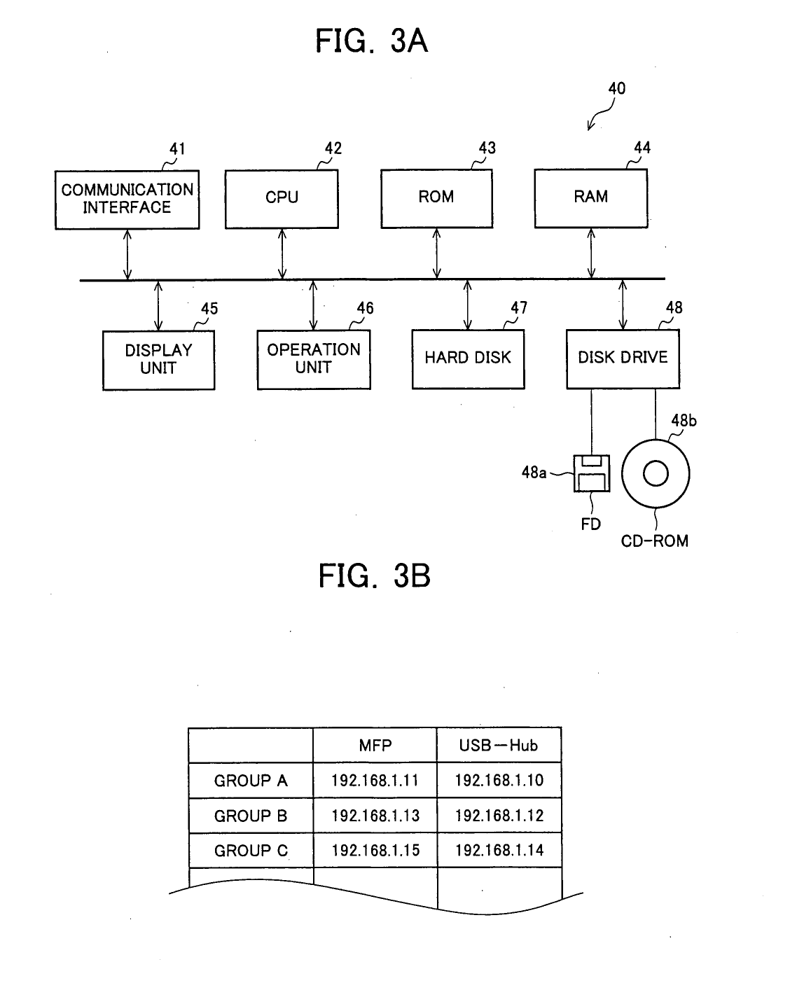

FIG. 3A is a block diagram of an example of a configuration of the server 40 (40A or 40B) of FIG. 2.

The server 40 comprises a communication interface 41, a CPU 42, a ROM 43, a RAM 44, a display unit 45, an operation unit 46, a hard disk 47, and a disk drive 48, and each of them is interconnected by way of a bus.

The communication interface 41 is an interface for data transmission and reception to and from the digital multi-function peripherals 20 and USB-Hubs 30 by way of the network N1 (LAN). The CPU 42 controls respective units according to programs stored in the ROM 43, the hard disk 47, and an FD (flexible disk) 48a or a CD-ROM 48b loaded to the disk drive 48. The CPU 42 has connections to the communication interface 41, the RAM 44, the display unit 45, the operation unit 46, the hard disk 47, and the disk drive 48 by way of the bus and performs data reading/writing, display control, key input control, and data communication control, etc. The operation unit 46 is a user interface which is used in cases that a system manager, etc., performs addition or change of various drivers or installation of application software and comprises a key board having cursor keys, numeral input keys, various function keys, etc., a mouse, and the like.

The hard disk 47 stores various programs to be executed by the CPU 42, the management table for the processing procedure that is described later, etc.

The server 40 is provided with application software for handling the data such as document data and image data, data conversion programs for converting data format, etc. besides the device drivers for various peripheral devices connected to the USB-Hubs 30.

The server 40 has a function of storing and managing GUI (Graphical User Interface) image data to be displayed on the operation unit of the digital multi-function peripheral 20 and supplying predetermined GUI image data to the digital multi-function peripherals in accordance with the progress of the information processing, when the information processing is executed utilizing the peripheral devices connected to the communication interface 41.

FIG. 3B shows the manner in which the digital multi-function peripherals (MFP) 20 and the USB-Hubs 30 are managed in groups, such as group A, group B, and group C, by the server 40, based on IP addresses thereof.

The server 40 recognizes the peripheral device when it is connected to the USB-Hub 30 and supports the information processing to be performed by cooperation of the connected peripheral device and the image processing apparatus, based on processing procedure information and group management information recorded on the management table.

Description will then be made of a specific example of the information processing enabled by the information processing system described above.

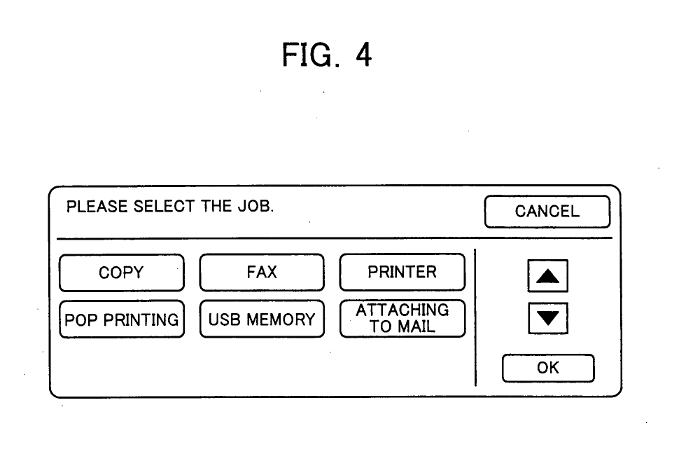

FIG. 4 shows a display example of a job selection screen displayed on the operation panel of the digital multi-function peripheral 20. Here, “copy”, “FAX”, and “printer” are jobs that can be utilized on the digital multi-function peripheral alone and “POP printing”, “USB memory”, and “attaching to mail” are jobs that can be executed utilizing the supporting function of the server, with the peripheral device connected to the USB-Hub 30 mentioned above.

### [POP Printing]

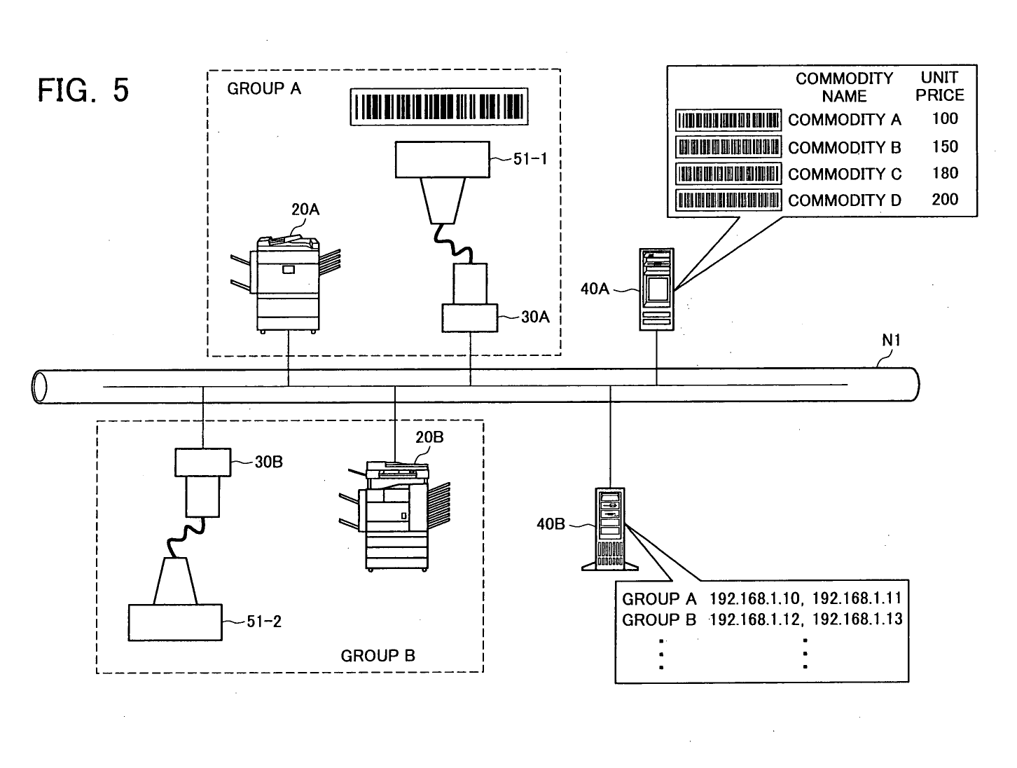

Firstly, description will be made of the “POP printing” job of reading out a bar code and printing it on a label, with reference to the FIGS. 5 to 8.

FIG. 5 shows an example of the POP printing being performed in two groups of group A and group B and indicates that the server 40A is provided with product database including a commodity name and unit price information and that the server 40B executes a group management for the digital multi-function peripheral 20A and the USB-Hub 30A as group A and the digital multi-function peripheral 20B and the USB-Hub 30B as group B according to the IP address. The server 40B stores a processing procedure management table memorizing the processing procedure of each job.

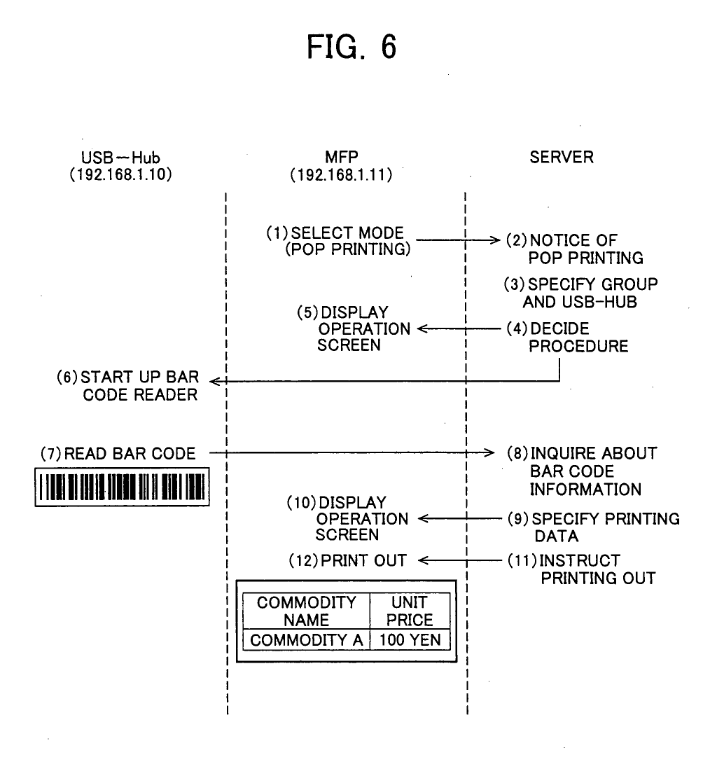

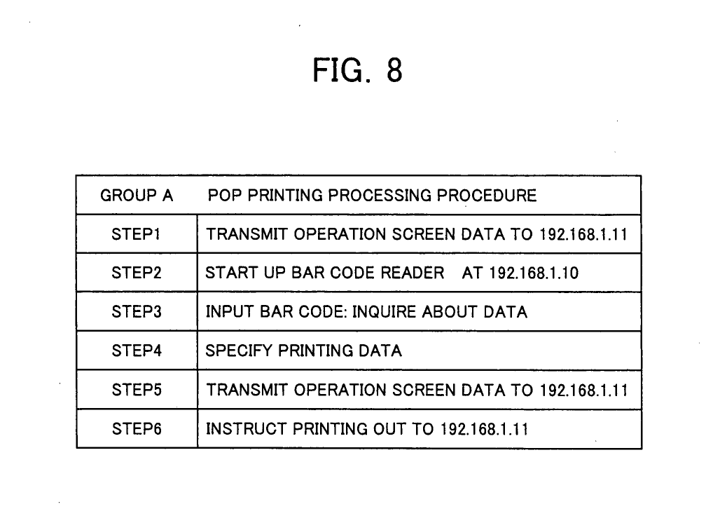

Description will then be made of processing operation in the case of the POP printing, using a processing sequence chart of FIG. 6. If the “POP printing” is selected on the job selection screen (FIG. 4) in the operation panel of the digital multi-function peripheral 20A (1), then the digital multi-function peripheral 20A notifies the server 40B of the selection of the POP printing (2). Upon receipt of this notice, the server 40B specifies the USB-Hub 30A of group A (3) and decides the procedure by taking out the management table recording the POP printing processing procedure (FIG. 8) out of various work processing procedures stored in advance (4).

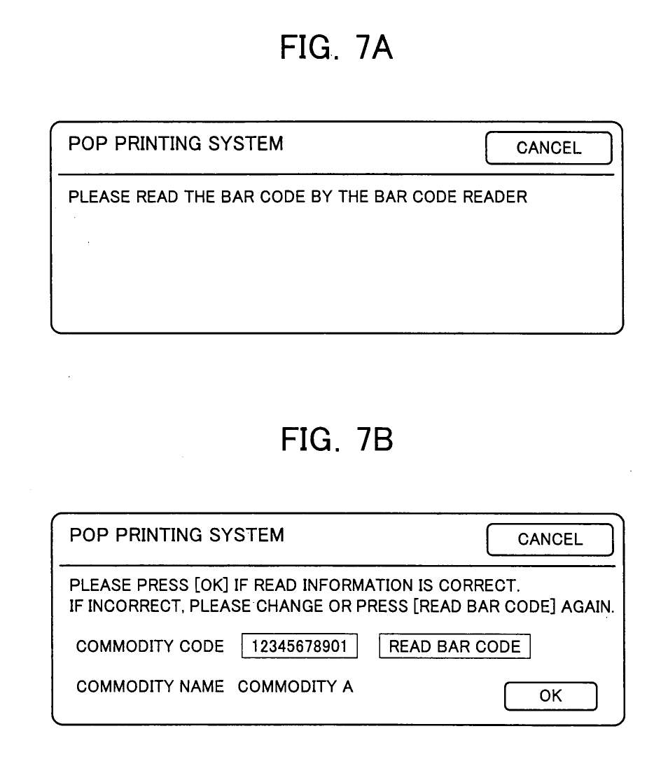

With the processing procedure decided, the server 40B transmits operation screen data to the digital multi-function peripheral 20A to display the screen of FIG. 7A (5) and starts up the bar code reader 51 (6). When a bar code is read out by the bar code reader 51 (7), the server 40B makes a bar code information inquiry about the read-out bar code to the server 40A (8), specifies printing data (9), transmits the screen data of FIG. 7B to the digital multi-function peripheral 20A (10), and confirms a printing out instruction (11). Thereafter, if the operation of the OK key that means the confirmation from the user is confirmed, then the digital multi-function peripheral 20A performs the POP printing including the trade name and unit price information, based on the printing data sent from the server 40B (12).

FIG. 8 shows the processing procedure of the POP printing stored in the server 40B and indicates that the processing procedure starts at the point where the “POP printing” has been selected on the job selection screen of FIG. 4 and the USB-Hub has been specified. Namely, the server 40B transmits the operation screen data of FIG. 7A to the digital multi-function peripheral 20A at STEP 1, starts up the bar code reader 51 at. STEP 2, after input of the bar code, makes the bar code information inquiry at STEP 3, specifies the printing data at STEP 4, transmits the screen data of FIG. 7B to the digital multi-function peripheral 20A at STEP 5, and gives the printing out instruction at STEP 6, thereby finishing the processing procedure.

### [Scan USB]

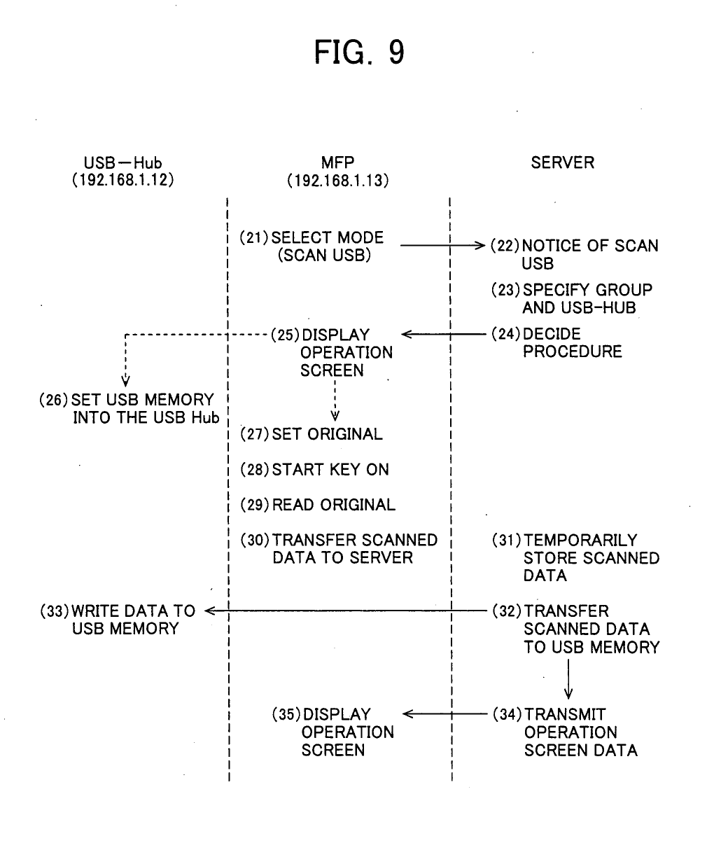

Description will then be made of the “scan USB” job of storing the image data scanned by the digital multi-function peripheral in the USB memory, with reference to FIGS. 9 to 11.

FIG. 9 shows the processing sequence chart in the scan USB. If the “scan USB” is selected on the job selection screen (FIG. 4) in the operation panel of the digital multi-function peripheral 20B (21), then the digital multi-function peripheral 20B notifies the server 40B of the selection of the “scan USB” (22). Upon receipt of this notice, the server 40B specifies the USB-Hub 30B of group B (23) and decides the procedure by taking out the management table which records the scan USB processing procedure (FIG. 11) out of various work processing procedures stored in advance (24).

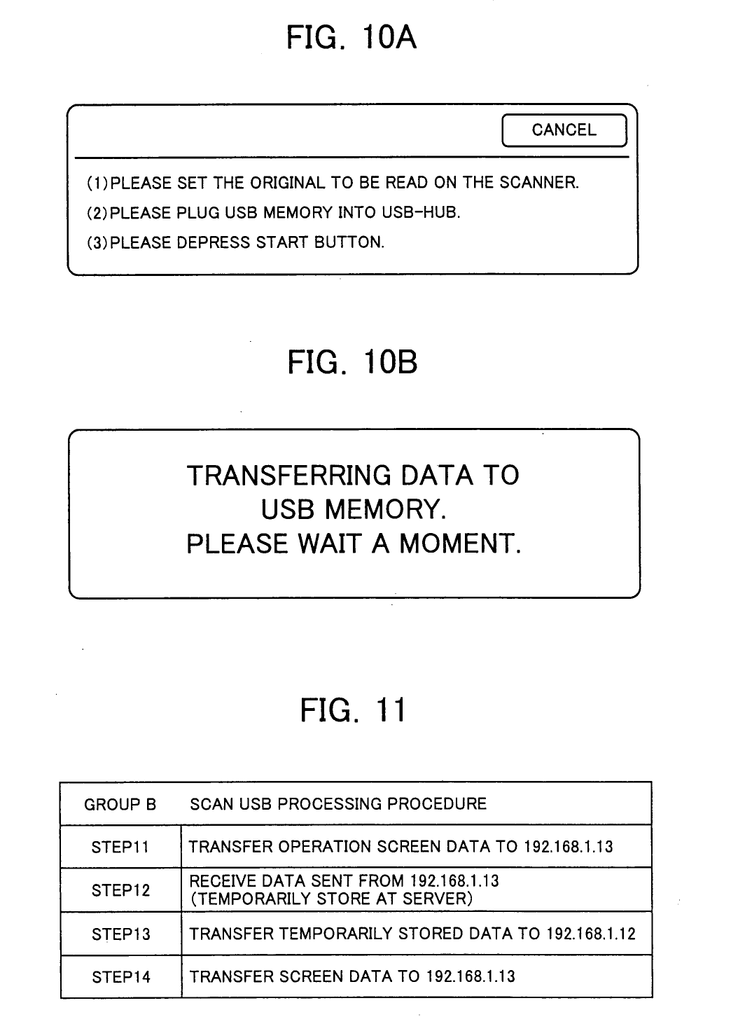

With the processing procedure decided, the server 40B transmits operation screen data to the digital multi-function peripheral 20B to display the screen of Fig. 10A (25). The user plugs the USB memory into the USB-Hub 30B (26), sets an original on the digital multi-function peripheral 20B (27) and presses a start key (28). When the original is read out (29), its image data is transferred to the server 40B (30) and the server 40B temporarily stores the received data (31), transfers (32) the stored data to the USB memory 52 by way of the USB-Hub 30B (33) and at the same time, transmits the screen data for displaying “data being transferred” to the digital multi-function peripheral 20B (34) and the digital multi-function peripheral 20B displays the screen of FIG. 10B (35).

FIG. 11 shows the processing procedure of the “scan USB” stored in the server and indicates that the processing procedure starts at the point where the scan USB has been selected on the job selection screen of FIG. 4 and the USB-Hub has been specified. Namely, the server 40B transmits the operation screen data of FIG. 10A to the digital multi-function peripheral 20B at STEP 11, receives and temporarily stores the data transmitted from the digital multi-function peripheral 20B at STEP 12, transfers the temporarily stored data to the USB memory 52 by way of the USB-Hub 30B at STEP 13, and transmits to the digital multi-function peripheral 20B the screen data of FIG. 10B notifying the data being transferred at STEP 14, thereby finishing the processing procedure.

Here, the processing may also be performed such as converting the format of the data temporarily stored in the server 40B to an arbitrary format.

### [USB Memory Printing]

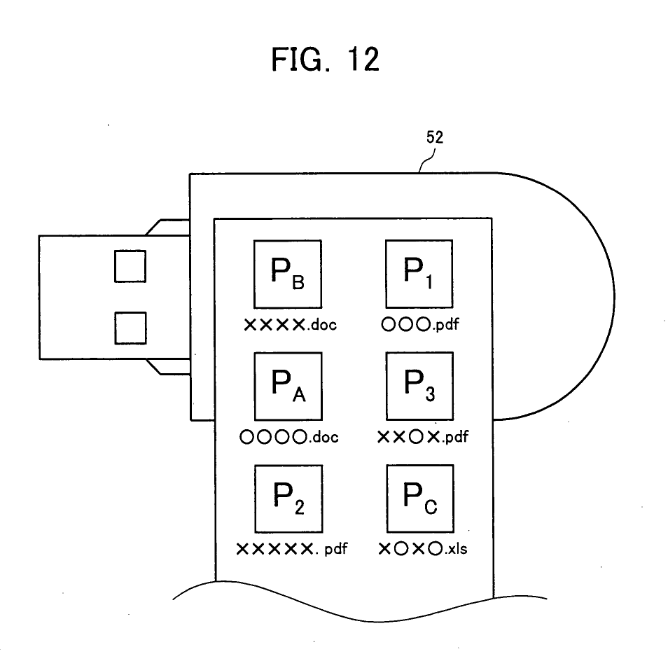

Description will then be made of a “USB memory printing” job of having document data stored in the USB memory printed by the digital multi-function peripheral, with reference to FIGS. 12 to 15.

FIG. 12 is a typical representation of how document data and image data produced by various types of application software are stored as files in the USB memory 52.

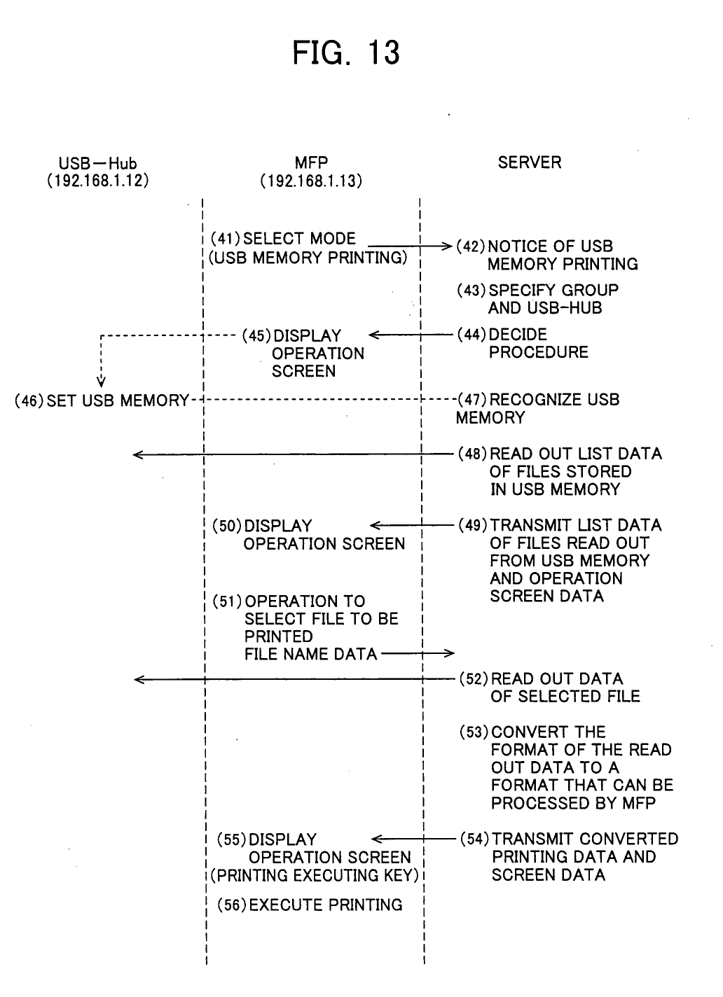

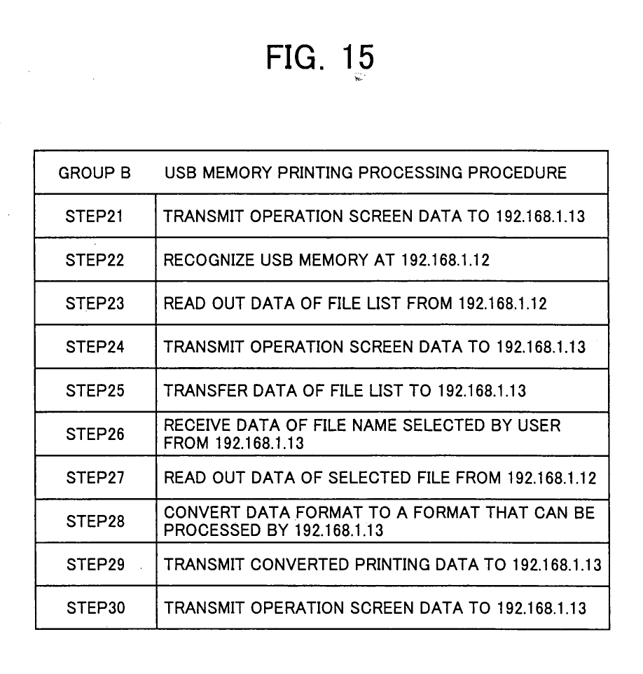

FIG. 13 shows the processing sequence chart in the USB memory printing. If the “USB memory printing” is selected on the job selection screen (FIG. 4) in the operation panel of the digital multi-function peripheral 20B (41), then the digital multi-function peripheral 20B notifies the server 40B of the selection of the USB memory printing (42). Upon receipt of this notice, the server 40B specifies the USB-Hub 30B of group B (43) and decides the procedure by taking out the management table that records the USB memory printing processing procedure (FIG. 15) out of various work processing procedures stored in advance (44).

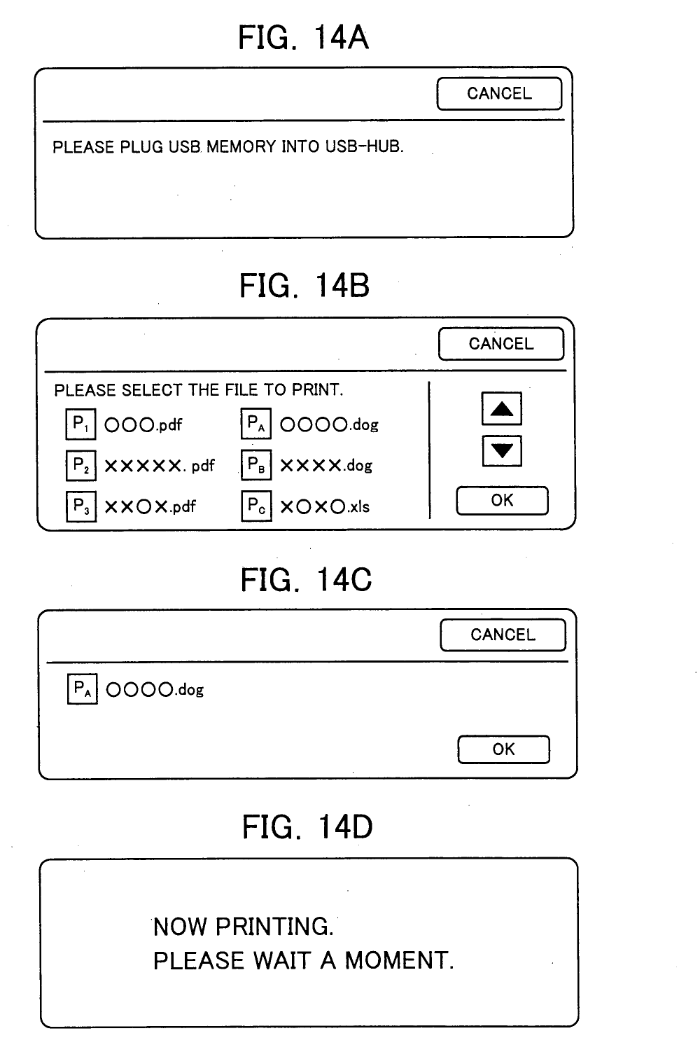

With the processing procedure decided, the server 40B transmits the operation screen data to the digital multi-function peripheral 20B to display the screen of FIG. 14A (45). If the USB memory is plugged into the USB-Hub 30B (46), the server 40B recognizes the USB memory (47), reads out list data of the files (see FIG. 12) stored in the USB memory (48), and transmits the list data together with the operation screen data for file selection (49). The digital multi-function peripheral displays the screen of FIG. 14B based on the data sent from the server 40B (50).

If the file to be printed is selected on the digital multi-function peripheral 20B, the file name data is transmitted from the digital multi-function peripheral 20B to the server 40B (51) and the server 40B reads out data of the selected file from the USB memory 52 (52), converts the format of the data to a format that can be processed by the digital multi-function peripheral 20B (53), and transmits the format converted data together with the screen data to the digital multi-function peripheral 20B (54). The digital multi-function peripheral 20B displays the screen of FIG. 14C based on the data sent from the server 40B (55) and if the OK key for executing the printing is pressed, then the printing is executed (56) while displaying the screen of FIG. 14D.

FIG. 15 shows the processing procedure of the “USB memory printing” stored in the server 40B and indicates that the processing procedure starts at the point where the USB memory printing has been selected on the job selection screen of FIG. 4 and the USB-Hub has been specified. Namely, the server 40B transmits the operation screen data of FIG. 14A to the digital multi-function peripheral 20B at STEP 21, recognizes the USB memory 52 being plugged into the USB-Hub 30B at STEP 22, reads out the list data of the files stored in the USB memory at STEP 23, transmits the screen data of the file selection screen of FIG. 14B at STEP 24, transfers the read-out list data of the files to the digital multi-function peripheral 20B at STEP 25, receives the data of the file name selected by the user from the digital multi-function peripheral 20B at STEP 26, reads out corresponding data from the USB memory based on the received file name data at STEP 27, converts the format of the read-out data to a format that can be processed by the digital multi-function peripheral 20B at STEP 28, transmits converted printing data to the digital multi-function peripheral 20B at STEP 29, and transmits the screen data of FIG. 14C at STEP 30, thereby finishing the processing procedure.

### [Attaching to Mail]

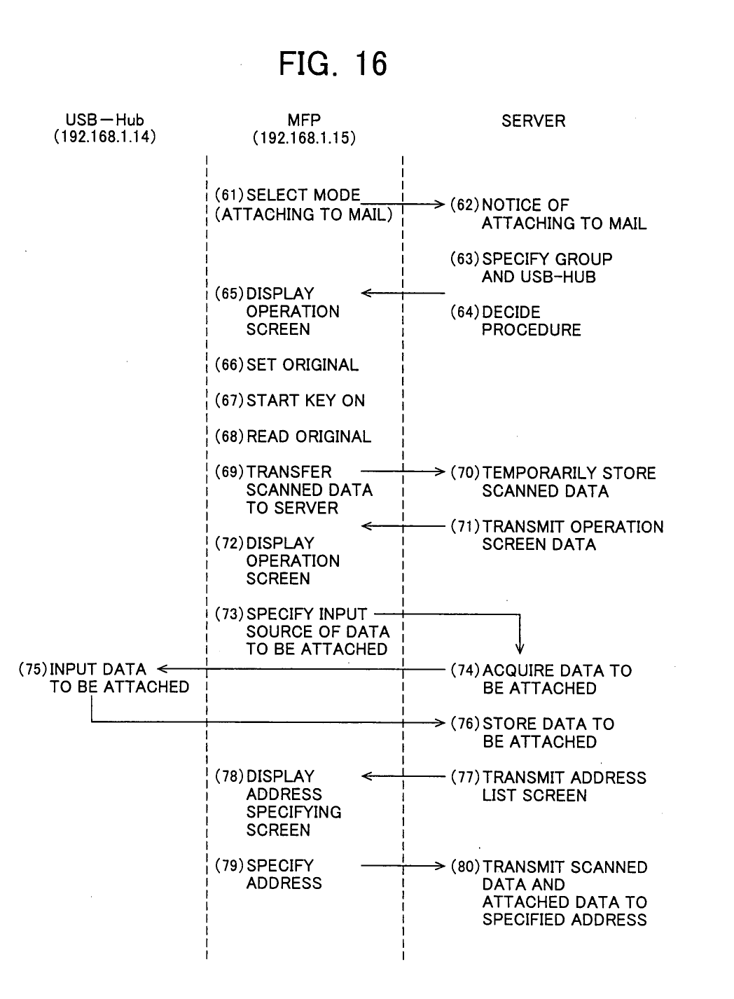

Description will then be made of an “attaching to mail” job of attaching image data generated by scanning an original or audio data to a mail, with reference to FIGS. 16 to 18.

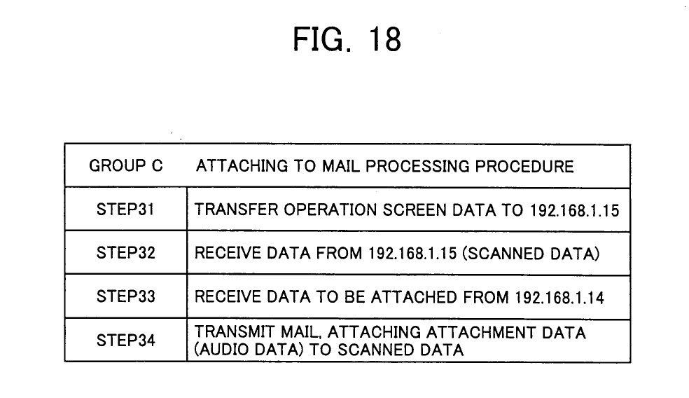

FIG. 16 shows the processing sequence chart in the “attaching to mail”. If the “attaching to mail” is selected on the job selection screen (FIG. 4) in the operation panel of the digital multi-function peripheral 20C (61), then the digital multi-function peripheral 20C notifies the server 40B of the selection of the attaching to mail (62). Upon receipt of this notice, the server 40B specifies the USB-Hub 30C of group C (63) and decides the procedure by taking out the management table which records the “attaching to mail” processing procedure (FIG. 18) out of various work processing procedures stored in advance (64).

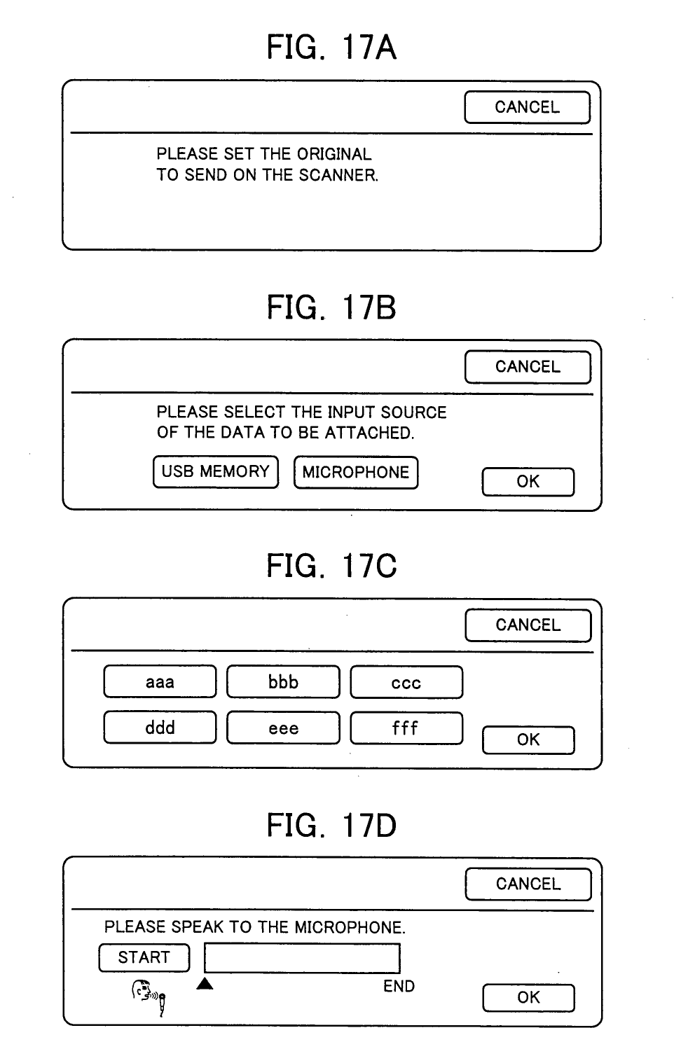

With the processing procedure decided, the server 40B transmits the operation screen data to the digital multi-function peripheral 20C to display the screen of FIG. 17A (65). If the user sets an original on the digital multi-function peripheral 20C (66) and presses the start key (67) and the original is read out (68), the image data is transferred to the server 40B (69) and the server 40B temporarily stores the received data (70).

Then, the server 40B transmits the screen data for selection of an input source of the data to be attached to a mail to the digital multi-function peripheral 20C (71) and the digital multi-function peripheral 20C displays the screen of FIG. 17B based on the received data (72). If the input source of the data to be attached is selected, the selection information is transmitted to the server 40B (73) and if, for example, the “USB memory” is selected as the input source, the server 40B accesses the USB memory (in this case, the USB memory is plugged into the USB-Hub 30C in advance) (74), the data to be attached is input from the USB memory (75), stores the data to be attached (76), and transmits the mail address list screen data (77). Based on the data, the digital multi-function peripheral 20C displays a mail address specifying screen of FIG. 17C (78) and, if the mail address is specified (79), transmits the information to the server 40B and the server 40B transmits the stored scanned data and the attached data to the mail address (80).

When the “microphone” is selected on the operation screen of FIG. 17B, the screen of FIG. 17D is displayed and audio data through the microphone can also be attached. In this case, the microphone 53 (FIG. 2) is to be plugged into the USB-Hub 30C.

While in the above embodiments, “USB memory” and “microphone” are displayed from the beginning on the operation screen for selecting the input source of the data to be attached, it may be so arranged that, “USB memory” or “microphone” will be displayed when they are plugged into the USB-Hub by using the function of recognizing connected devices provided in the server 40. In the case of this job, it may be so arranged that both of the document data from the USB memory and the audio data from the microphone can be attached. In such a case, such USB-Hub will be used that is provided with a plurality of connectors.

FIG. 18 shows the processing procedure of the “attaching to mail” to be performed by the server and indicates that the processing procedure starts at the point where the “attaching to mail” has been selected on the job selection screen of FIG. 4 and the USB-Hub has been specified. Namely, the server transmits the operation screen data of FIG. 17A to the digital multi-function peripheral 20C at STEP 31, receives the scanned data from the digital multi-function peripheral 20C at STEP 32, receives the data to be attached from the USB memory by way of the USB-Hub 30C at STEP 33, and transmits the scanned data with the attachment data (document data and/or audio data) attached thereto to the mail address at STEP 34, thereby finishing the processing procedure.

The present invention enables executing various types of information processing, using desired peripheral devices, without increasing the function of the image processing apparatus.

The present invention enables executing information processing by combining various peripheral devices with the image processing apparatus, without equipping the apparatus with the device driver and application program for every peripheral device to be used.

Furthermore, the present invention makes it unnecessary for the image processing apparatus to prepare many kinds of GUI screen data for each of various types of information processing and therefore, substantially reduces the load of development of the programs used for the image processing apparatus.

1. An information processing system in which an image processing apparatus, a communication connection device to which a peripheral device is connected, and a server are connected to a network, wherein
the server has a function of managing the connection between the image processing apparatus and the communication connection device and supporting information processing to be performed by the peripheral device connected to the communication connection device in cooperation with the image processing apparatus.

2. The information processing system as defined in claim 1, wherein
the network is a LAN.

3. The information processing system as defined in claim 1, wherein
the image processing apparatus and the communication connection device are assigned their IP addresses.

4. The information processing system as defined in claim 1, wherein
a group management is executed on the image processing apparatus and the communication connection device by the server.

5. The information processing system as defined in claim 4, wherein
the group management is performed according to IP addresses.

6. The information processing system as defined in claim 1, wherein
the communication connection device is a USB hub.

7. A server for connecting to a network an image processing apparatus and a communication connection device to which a peripheral device is connected, the server equipped with a device driver that enables the peripheral device connected to the communication connection device to be utilized to work in cooperation with the image processing apparatus.

8. The server as defined in claim 7, having a group management function of executing a group management on the image processing apparatus and the communication connection device.

9. The server as defined in claim 7, provided with a connected device recognizing function of recognizing the peripheral device connected to the communication connection device when the peripheral device is connected to the communication connection device.

10. The server as defined in claim 7, provided with a processing procedure management table recording a processing procedure for executing information processing utilizing the peripheral device connected to the communication connection device when the peripheral device is connected to the communication connection device.

11. The server as defined in claim 10, wherein the processing procedure corresponding to the connected peripheral device is decided based on management information of the group management and information on the connected device as recognized by the connected device recognizing function.

12. The server as defined in claim 10, storing and managing GUI screen data to be displayed on an operation unit of the image processing apparatus and providing the image processing apparatus with predetermined GUI screen data in accordance with the progress of the information processing.

13. The server as defined in claim 10, equipped with a function of converting the format of the data provided by the peripheral device that can not be handled by the image processing apparatus to a format that can be handled by the image processing apparatus.
